(19) United States
(12) Patent Application Publication
(10) Pub. No.: US 2013/0005531 A1
(43) Pub. Date: Jan. 3, 2013

(54) SHIFT CONTROL SYSTEM AND METHOD FOR AUTOMATED MANUAL TRANSMISSION

(75) Inventors: Byung Jun Sung, Anyang (KR); Sang Pil Jang, Seoul (KR)

(73) Assignee: HYUNDAI MOTOR COMPANY, Seoul (KR)

(21) Appl. No.: 13/299,628

(22) Filed: Nov. 18, 2011

(30) Foreign Application Priority Data
Jun. 30, 2011 (KR) 10-2011-0065169

(51) Int. Cl. B60W 10/02; B60W 10/06

(52) U.S. Cl. 477/84

(57) ABSTRACT

A shift control system and method for a vehicle equipped with an automated manual transmission is disclosed herein. In the shift control system, upon determining that shifting has started and a clutch has been released, an engine speed is reduced by fully opening a valve of a hydraulic cooling unit when. The engine speed is then synchronized with an input shaft speed and the clutch is rejoined once the engine speed is synchronized with the input shaft speed.

### CROSS-REFERENCE TO RELATED APPLICATION

This application claims under 35 U.S.C. §119(a) the benefit of Korean Patent Application No. 10-2011-0065169 filed Jun. 30, 2011, the entire contents of which are incorporated herein by reference.

### BACKGROUND

(a) Technical Field

The present invention relates to a shift control method for an automated manual transmission. More particularly, it relates to a shift control method for an automated manual transmission, which can improve driving performance by reducing duration of interruption of power transmission during shifting.

(b) Background Art

Large commercial vehicles have been increasingly adopting Automated Manual Transmissions (AMTs) in order to improve fuel efficiency, power performance, and driver's convenience. An automated manual transmission (also known as self-changing transmission, clutchless manual transmission, flappy-paddle gearbox, or paddle-shift gearbox) is a system which uses electronic sensors, pneumatics, processors and actuators to execute gear shifts on the command of the driver or by a computer. AMTs remove the need for a clutch pedal which the driver otherwise needs to depress before making a gear change, since the clutch itself is actuated by electronic equipment which can synchronize the timing and torque required to make gear shifts quick and smooth. The system was designed by automobile manufacturers to provide a better driving experience, especially in cities where congestion frequently causes stop-and-go traffic patterns.

Typically, commercial hybrid vehicles include an engine, an engine clutch, a motor, and an AMT. These engine clutches include an automatic release unit, and AMTs include an automatic shift unit in addition to a typical manual transmission. In a shift control method using an AMT, a Transmission Control Unit (TCU) requests an Engine Control Unit to reduce a torque, and the torque of an engine is reduced. Torque inputted into the AMT is to maintained at zero by reducing the output torque of the engine and releasing the engine clutch to separate power between the engine and the motor. Thereafter, the gears are released, and the gear teeth of shifted step are engaged.

FIG. 1 is a graph illustrating a shifting process (three steps) of a large commercial vehicle on an uphill road. In the first step, the clutch is released for shifting to separate power between the engine and the motor (see the first arrow). After the clutch is released, the input shaft speed (input speed of shift gears) is reduced, and the engine speed is reduced by the engine friction while the vehicle speed is being reduced on an uphill road (see the second arrow). In the second step, the engine speed and the input shaft speed are synchronized to rejoin the clutch without any impact, and then the gear teeth are engaged. In the third step, the clutch is rejoined in a state where the engine speed and the input shaft speed are being synchronized (see the third arrow).

However, an AMT that is gear-shifted according to the above control method has an advantage of low power loss due to better power transmission efficiency than an automatic transmission, but also has a limitation in reduction of drivability due to interruption of power transmission during the shifting.

More specifically, since the input shaft speed is reduced, and the engine speed is naturally reduced after the release of the clutch at an uphill road, a difference of deceleration between the input shaft speed and the engine speed occurs.

In other words, although the gear teeth are engaged upon shifting after the release of the clutch, that is, a state where the input shaft speed has been already reduced, the clutch cannot be rejoined until the engine speed is synchronized with the input shaft speed. Accordingly, the shifting duration is elongated, and the synchronization between the input shaft speed and the engine speed is also delayed, causing an impact upon rejoining of the clutch. Additionally, since power is interrupted for two seconds during the shifting, the power performance of a vehicle may also be reduced.

The above information disclosed in this Background section is only for enhancement of understanding of the background of the invention and therefore it may contain information that does not form the prior art that is already known in this country to a person of ordinary skill in the art.

### SUMMARY OF THE DISCLOSURE

The present invention provides a shift control system and method for an automated manual transmission, which can minimize shift duration by increasing the deceleration of an engine and improving the driving performance by shortening power interruption duration upon shifting, by operating a cooling fan upon shifting to increase an engine load.

In one aspect, the present invention provides a shift control system and method of a vehicle equipped with an automated manual transmission. In particular, the system/method initiates by determining whether shifting has started and a clutch has released. Subsequently an engine speed is reduced by fully opening an open/close (first) valve of a hydraulic cooling unit once the shifting has started and the clutch has been released. The engine speed is then synchronized with an input shaft speed and the clutch is rejoined once the engine speed has been synchronized with the input shaft speed.

In an exemplary embodiment, the engine speed may be reduced by requesting a signal which fully opens the open/close (first) valve from a cooling controller when a hybrid control unit receives a signal at the beginning of the shifting and the release of the clutch from a transmission control unit. A hydraulic pump is then operated via an engine when the open/close valve connected between the hydraulic pump and a hydraulic motor is fully opened via a request from a hybrid control unit which produces an open signal. A cooling fan using a turning force of the hydraulic motor is then operated via a hydraulic motor using a hydraulic pressure generated in the hydraulic pump.

Other aspects and preferred embodiments of the invention are discussed infra.

### BRIEF DESCRIPTION OF THE DRAWINGS

The above and other features of the present invention will now be described in detail with reference to certain exemplary embodiments thereof illustrated the accompanying drawings which are given hereinbelow by way of illustration only, and thus are not limitative of the present invention, and wherein:

FIG. 1 is a graph illustrating a shifting process (three steps) of a large commercial vehicle at an uphill road;

FIG. 2 is a diagram illustrating an apparatus for shortening shifting duration in an AMT-equipped vehicle according to an embodiment of the present invention;

FIG. 3 is a graph illustrating fan power consumption according to the speed of a cooling fan in a hydraulic cooling apparatus according to an embodiment of the present invention;

FIG. 4 is a flowchart illustrating a shift control method of an AMT-equipped vehicle according to an embodiment of the present invention; and

FIG. 5 is a graph illustrating a comparison of engine deceleration duration of a typical AMT-equipped vehicle with engine decoration duration according to an operation of a cooling fan according to an embodiment of the present invention.

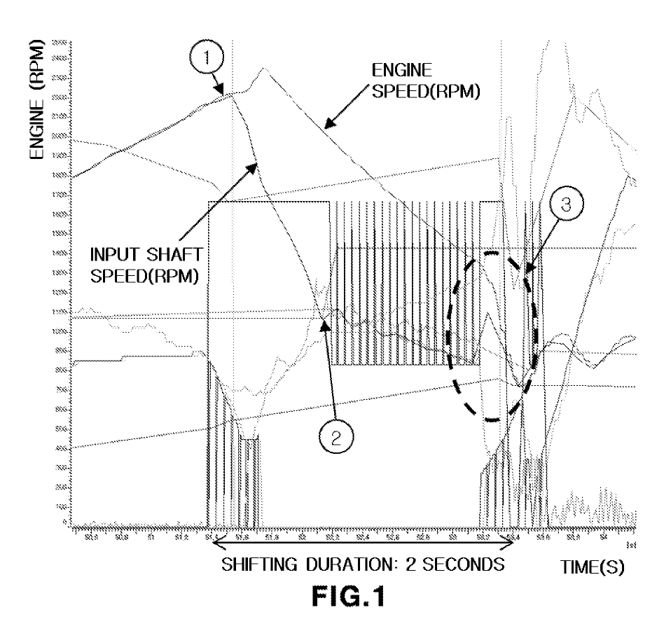

Reference numerals set forth in the Drawings includes reference to the following elements as further discussed below:
10: engine
11: hydraulic pump
12: hydraulic motor
13: open/close valve
14: cooling controller
15: HCU
16: cooling fan
17: radiator

It should be understood that the appended drawings are not necessarily to scale, to presenting a somewhat simplified representation of various preferred features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Hereinafter reference will now be made in detail to various embodiments of the present invention, examples of which are illustrated in the accompanying drawings and described below. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other embodiments, which may be included within the spirit and scope of the invention as defined by the appended claims.

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuels derived from resources other than petroleum). As referred to herein, a hybrid vehicle is a vehicle that has two or more sources of power, for example both gasoline-powered and electric-powered vehicles.

The above and other features of the invention are discussed infra.

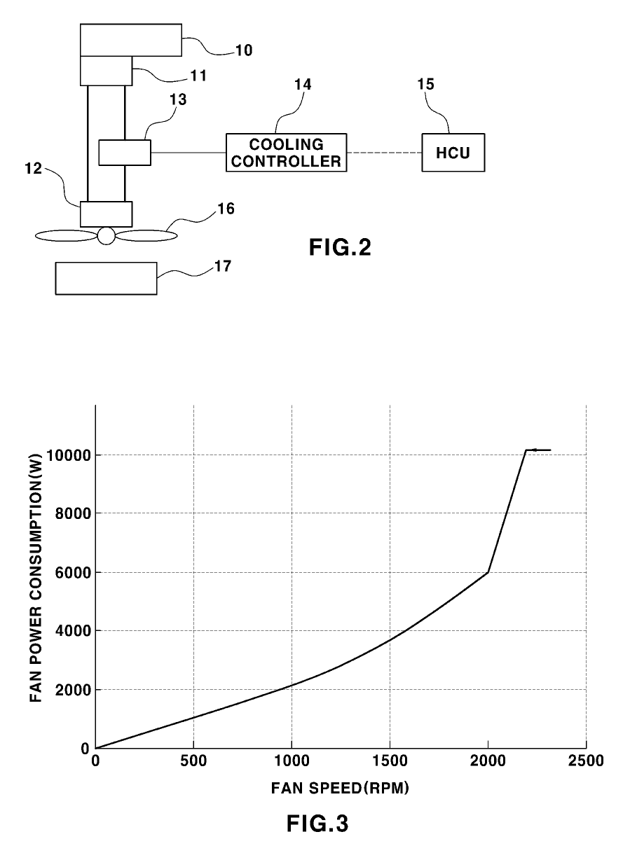

FIG. 2 is a diagram illustrating an apparatus/system for shortening shifting duration in an AMT-equipped vehicle according to an embodiment of the present invention. The present invention relates to a shift control method of a vehicle equipped with an automated manual transmission, which can shorten shifting duration and power interruption duration during shifting and reduce an impact of a clutch upon shifting, by increasing the load of auxiliary machinery of an engine 10 using a cooling fan 16 to increase the natural deceleration of the engine 10.

The present invention may be applied to vehicles equipped with an Automated Manual Transmission (AMT), particularly, large hybrid vehicles (e.g., buses). By shortening shifting duration, it is possible to minimize deceleration of a vehicle and an impact of a clutch during an up-shift (i.e., a gear shift from low to high) on an uphill road and improve the acceleration performance. The present invention may particularly shorten the shifting duration by more quickly synchronizing the engine speed with the input shaft speed by increasing deceleration of the engine 10 upon shifting in a vehicle equipped with an AMT as described above.

An apparatus for shortening shifting duration according to an embodiment of the present invention may include a shifting and vehicle speed sensing unit, a vehicle control unit configured to receive a signal from the shifting and vehicle speed sensor and control the overall operation of the cooling fan 16, and a hydraulic cooling unit controlled by a signal from the vehicle controller.

The shifting and vehicle speed sensing unit may include a shifting sensor for sensing shifting by a driver, an input shaft speed sensor for sensing the input shaft speed upon shifting, an engine speed sensor for sensing the engine speed, and a clutch sensor for sensing release and joining of the clutch. The shifting and vehicle speed sensing unit quickly reduces the engine speed after the clutch release by sensing shifting and engine speed through the shifting sensor, the engine speed sensor, and the clutch sensor collectively.

The vehicle control unit may include a Hybrid Control Unit (HCU) 15 configured to take charging of the overall control of a vehicle such as large hybrid bus, a Transmission Control Unit (TCU) for controlling the overall operation of shift gears upon shifting, and a cooling controller 14 for controlling the operation of the cooling fan 16. The HCU 15 may communicate with the TCU, and control the cooling fan 16 by sending a signal to the cooling controller 14 when the engine speed needs to be reduced during the shifting.

The cooling controller 14 may be configured to control the operation of an open/close valve 13 to control the hydraulic pressure in the system/apparatus, and to control the speed of the cooling fan 16 in accordance with the temperature of engine cooling water.

The hydraulic cooling unit may include a hydraulic pump 11 connected to the engine 10 to quickly reduce the speed of the engine 10, a hydraulic motor 12 operated via hydraulic pressure generated from the hydraulic pump 11, the cooling fan 16 operated by the hydraulic motor 12, and the open/close valve 13 operated upon receiving a signal from the cooling controller 14. The cooling fan 16 may be disposed in a rearward section of a radiator 17 that is located in the front of a vehicle, and may serve to cool the engine 10 by fluidly communicating cool air into the inside of the vehicle through the radiator 17 according to the operation of the hydraulic motor 12.

The open/close valve 13 may be disposed between the hydraulic motor 12 and the hydraulic pump 11, and may be configured to receive a signal from the cooling controller 14 to open and close a fluid passage for delivering a hydraulic pressure generated from the hydraulic pump 11 to the hydraulic motor 12. The open/close valve 13 may be opened at a ratio of about 0% to about 100% by the cooling controller 14. The more the open/close valve 13 is opened, the more the hydraulic pressure that is delivered to the hydraulic motor 12. Due to the increase in the hydraulic pressure, the output of the hydraulic motor 12 increases, and thus the load of the cooling fan 16 increases as a result. Since the responsive property of the open/close valve 13 is about 0.5 seconds, it may be sufficient to increase the deceleration of the engine within a shifting duration of, e.g., about 1 to about 2 seconds.

FIG. 3 is a graph illustrating fan power consumption according to the speed of a cooling fan in a hydraulic cooling apparatus according to an embodiment of the present invention. As shown in FIG. 3, as the speed of the cooling fan increases, the fan power consumption (load) rapidly increases.

Hereinafter, a method for shortening shifting duration according to an embodiment of the present invention will be described in detail with reference to the accompanying drawings.

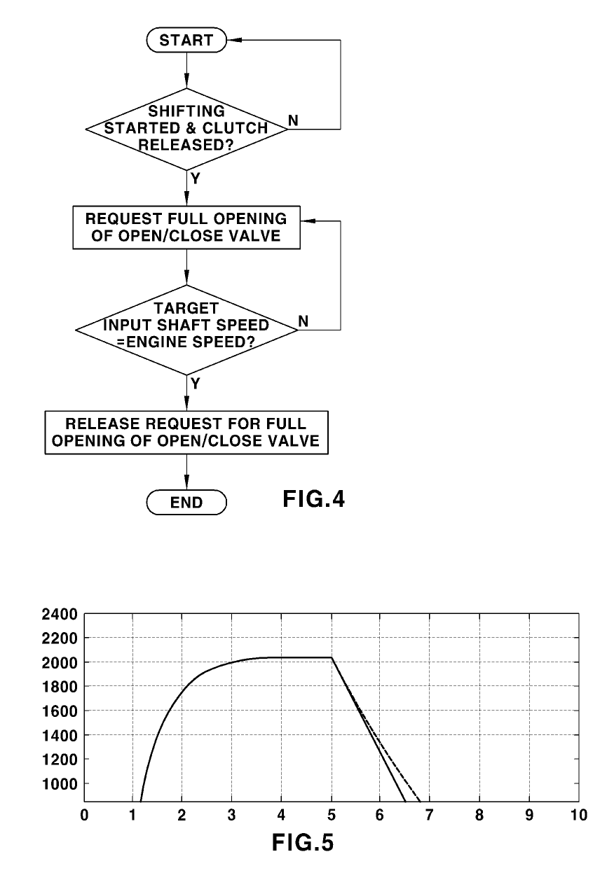

FIG. 4 is a flowchart illustrating a shift control method of an AMT-equipped vehicle according to an embodiment of the present invention. For example, when a shift lever is operated and a clutch is released for shifting on an uphill road, the TCU may be configured to receive signals from the shifting sensor and the clutch sensor to sense the initial of the shifting and the release of the clutch and send a signal to the HCU 15. Next, if the HCU 15 receives a signal indicating that shifting has initiated and the clutch has been released from the TCU, the HCU 15 then requests a signal to fully opening the open/close valve 13 from the cooling controller 14.

Subsequently, the open/close valve 13 may be 100% opened upon receiving the full opening signal from the HCU 15, and the hydraulic motor 12 is then operated by hydraulic pressure generated from the hydraulic pump 11 through the open/close valve 13. The cooling fan 16, in the illustrative embodiment of the present invention may be rotated at the maximum speed by the hydraulic motor 12.

Since the load on auxiliary machinery of the engine 10 increases due to the speed increase of the cooling fan 16, the deceleration of the engine 10 also increases. Thus, the engine speed is quickly reduced and synchronized with the input shaft speed due to the speed increase of the cooling fan 16, and then gear teeth may be engaged, and the clutch may be rejoined in a more efficient manor.

Therefore, when the engine speed almost reaches the input shaft speed, and it becomes time to rejoin the clutch, the HCU 15 may release the cooling controller 14 from the request for the full opening of the open/close valve 13. Accordingly, by increasing the engine load using the cooling fan 16 during the shifting, the deceleration of the engine 10 can be increased, and thus the shifting duration can be minimized. Also, the driving performance can be improved by shortening the power interruption duration during the shifting.

FIG. 5 is a graph illustrating a comparison of engine deceleration duration of a typical AMT-equipped vehicle with engine decoration duration according to an operation of a cooling fan according to an embodiment of the present invention.

Compared with natural deceleration duration taken from about 2000 RPM to about 1,000 RPM, (i.e., an engine RPM upon typical shifting), when the open/close valve 13 operates after about 0.5 seconds, and the engine 10 is decelerated according to an embodiment of the present invention, the shifting duration is reduced by about 0.25 seconds compared to when the engine 10 is naturally decelerated. Accordingly, the shifting duration can be reduced by about 12% compared to a related art.

According to illustrative embodiments, a shift control system and method for an automated manual transmission advantageously is able to minimize shifting duration by increasing the engine deceleration and improve the driving performance by shortening power interruption duration upon shifting since a driving force of the engine using a cooling fan upon shifting is consumed.

The invention has been described in detail with reference to preferred embodiments thereof. However, it will be appreciated by those skilled in the art that changes may be made in these embodiments without departing from the principles and spirit of the invention, the scope of which is defined in the appended claims and their equivalents.

What is claimed is:

1. A shift control method of a vehicle equipped with an automated manual transmission, comprising:
determining, by a plurality of sensors, whether shifting starts and a clutch is released;
reducing an engine speed by fully opening a valve of a hydraulic cooling unit, based on a signal from a controller in communication with the plurality of sensors upon determining that shifting has started and the clutch has been released;
synchronizing the engine speed with an input shaft speed; and
rejoining the clutch in a state where the engine speed is synchronized with the input shaft speed.

2. The shift control method of claim 1, wherein the reducing of the engine speed comprises:
requesting a signal of full opening of the open/close valve from a cooling controller when a hybrid control unit receives a signal of the beginning of the shifting and the release of the clutch from a transmission control unit;
operating a hydraulic pump by an operation of an engine when the open/close valve connecting between a hydraulic pump and a hydraulic motor is fully opened according to the request of the hybrid control unit for the opening signal; and
operating a cooling fan using a turning force of the hydraulic motor by operating the hydraulic motor using a hydraulic pressure generated in the hydraulic pump.

3. An apparatus, comprising:
a plurality of sensors configured to determine whether shifting starts and a clutch is released;
a first controller configured to communicate with the plurality of sensors and generate a signal in response to a determination that shifting has begun and the clutch has been released, and
a hydraulic cooling unit configure to reduce an engine speed by fully opening an valve upon receiving a signal from the controller indicating that shifting has started and the clutch has been released, wherein engine speed is synchronized with an input shaft speed and the clutch is rejoined once the engine speed is synchronized with the input shaft speed via the hydraulic pressure received from the hydraulic cooling unit.

4. The shift control method of claim 3, further comprising:
a second controller configured to reduce the engine speed by requesting a signal which fully opens the valve when the first controller receives a signal from the plurality of sensors that shifting has initiated and the clutch has been released;
a hydraulic pump configured to control the operation of an engine when the valve in-between the hydraulic pump and a hydraulic motor is fully opened by the first controller; and
a cooling fan using a turning force of the hydraulic motor operated by the hydraulic motor using hydraulic pressure generated in the hydraulic pump.
